(19) United States
(12) Patent Application Publication
(10) Pub. No.: US 2011/0221117 A1
(43) Pub. Date: Sep. 15, 2011

(54) IMAGE ERASING APPARATUS AND SHEET CARRYING METHOD OF IMAGE ERASING APPARATUS

(75) Inventors: Hiroyuki Taki, Shizuoka (JP); Isao Yahata, Shizuoka (JP); Takahiro Kawaguchi, Shizuoka (JP); Hiroyuki Taguchi, Shizuoka (JP); Hiroyuki Tsuchihashi, Shizuoka (JP); Ken Iguchi, Shizuoka (JP)

(73) Assignees: Kabushiki Kaisha Toshiba, Tokyo (JP); Toshiba Tec Kabushiki Kaisha, Tokyo (JP)

(21) Appl. No.: 13/038,337

(22) Filed: Mar. 1, 2011

Related U.S. Application Data
(60) Provisional application No. 61/312,085, filed on Mar. 9, 2010.

(51) Int. Cl. B65H 7/12; B41J 2/325

(52) U.S. Cl. 271/4.03

(57) ABSTRACT

An image erasing apparatus includes a sheet stacking tray, a first sheet feeding roller, a pair of separation rollers, a pair of second sheet feeding rollers, a carrying detection sensor, a sheet carrying device, a heating device, and a stacking device. The pair of the separation rollers is provided downstream of the first sheet feeding roller configured to take in sheets from the sheet stacking tray and separates the sheets. The pair of the second sheet feeding rollers is provided downstream of the pair of the separation rollers and carries the sheets in the sheet carrying direction. The carrying detection sensor is provided in the vicinity of the pair of the second sheet feeding rollers and detects passing of the sheets. The heating device erases images formed on the sheets by heating the sheets to or above a color erasing temperature of a developer. Upon detection of double feeding of the sheets on the basis of an output of the carrying detection sensor, the control device rotationally drives one of the pair of the separation rollers in the sheet carrying direction and the other in a direction opposite to the sheet carrying direction by a certain distance.

### CROSS-REFERENCE TO RELATED APPLICATIONS

This application is based upon and claims the benefit of priority from Provisional U.S. Application No. 61/312,085, filed on 9 Mar. 2010, the entire contents of which are incorporated herein by reference.

### FIELD

Embodiments described herein relate generally to an image erasing apparatus and to a sheet carrying method of an image erasing apparatus.

### BACKGROUND

An image forming apparatus configured to form an image using a color-erasable developer and a color erasing apparatus is introduced recently to meet a demand of resource saving. The color erasing apparatus erases an image by erasing the color of a color-erasable developer by applying heat or light to a recording medium on which the image is formed using the color-erasable developer. Hence, the recording medium after color erasing can be reused.

After images are formed on recording media, the recording media may be stapled or a sticky note may be laminated thereto. Such recording media may get stuck in a recording medium carrying path and possibly cause a jamming or damage to the apparatus.

To eliminate this inconvenience, there is proposed a technique of providing a detection device that detects double feeding and stopping the carrying of recording media upon detection of the double feeding.

### BRIEF DESCRIPTION OF THE DRAWINGS

FIG. 1 is a view schematically showing the configuration of an image erasing apparatus according to one embodiment of the invention;

FIG. 2 is a perspective view showing the internal structure of the image erasing apparatus shown in FIG. 1;

FIG. 3 is a view of a sheet carrying mechanism of the image erasing apparatus shown in FIG. 1 when viewed from the bottom;

FIG. 4 is a cross section showing the structure of separation rollers of the image erasing apparatus shown in FIG. 1;

FIG. 5 is a cross section showing the structure of second sheet feeding rollers of the image erasing apparatus shown in FIG. 1;

FIG. 6 is a block diagram showing an example of the configuration of the image erasing apparatus shown in FIG. 1;

FIG. 7(a) through FIG. 7(d) are views used to describe a carrying method of unstapled sheets;

FIG. 8(a) through FIG. 8(e) are views used to describe a carrying method of a bundle of stapled sheets; and

FIG. 9 is a view schematically showing the configuration of a major portion in an application example of the image erasing apparatus of the invention.

### DETAILED DESCRIPTION

According to an embodiment of the invention, an image erasing apparatus includes a sheet stacking tray, a first sheet feeding roller, a pair of separation rollers, a pair of second sheet feeding rollers, a carrying detection sensor, a sheet carrying device, a heating device, and a stacking device.

The sheet stacking tray feeds sheets from which images to be erased. The first sheet feeding roller takes in the sheets from the sheet stacking tray. A pair of the separation rollers is provided downstream of the first sheet feeding roller in a sheet carrying direction and separates sheets. A pair of the second sheet feeding rollers is provided downstream of a pair of the separation rollers in the sheet carrying direction and carries the sheets in the sheet carrying direction. The carrying detection sensor is provided in the vicinity of a pair of the second sheet feeding rollers and detects passing of the sheets.

The sheet carrying device carries the sheets. The heating device erases images formed on the sheets by heating the sheets to or above a color erasing temperature of a developer. The stacking device stacks the sheets from which the images are erased. The control device, upon detection of double feeding of the sheets on the basis of an output of the carrying detection sensor, rotationally drives one of a pair of the separation rollers in the sheet carrying direction and the other in a direction opposite to the sheet carrying direction by a certain distance.

Hereinafter, one embodiment of the invention will be described in detail in the context of accompanying drawings.

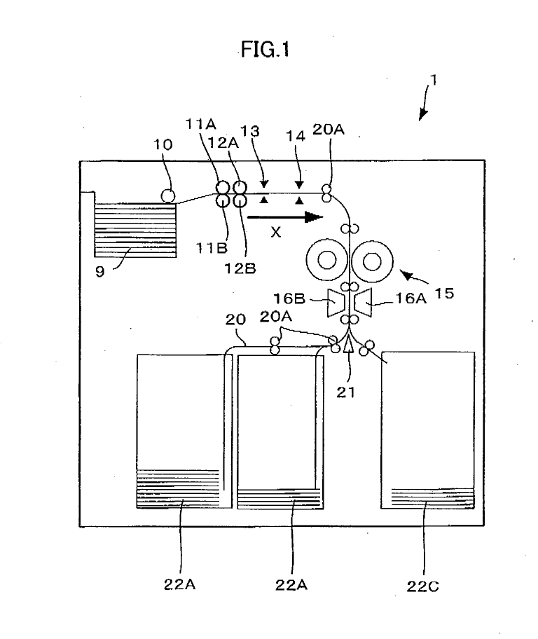

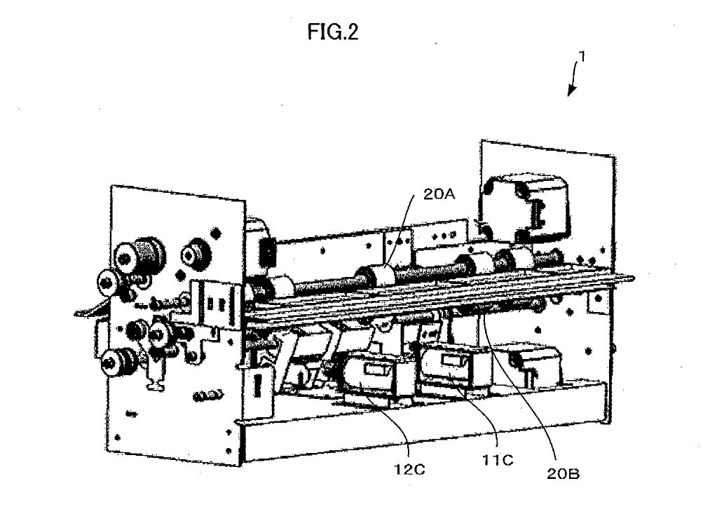

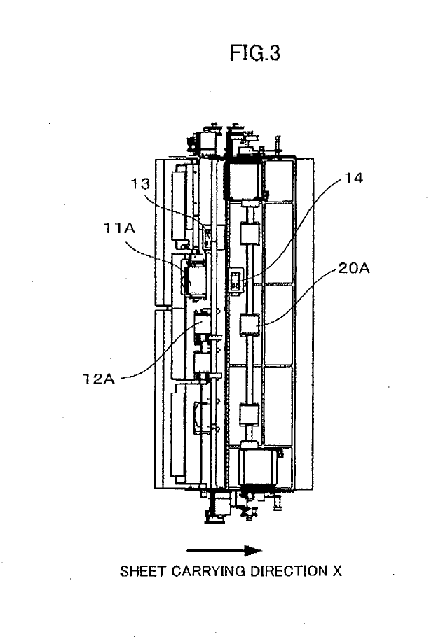

FIG. 1 is a view schematically showing the configuration of an image erasing apparatus 1 according to one embodiment of the invention. FIG. 2 is a perspective view showing the internal structure of the image erasing apparatus 1 shown in FIG. 1. FIG. 3 is a view of a sheet carrying mechanism of the image erasing apparatus 1 shown in FIG. 1 when viewed from the bottom.

As is shown in FIG. 1, the image erasing apparatus 1 includes a sheet stacking tray 9, a first sheet feeding roller 10, a pair of separation rollers 11A and 11B, a pair of second sheet feeding rollers 12A and 12B, a first carrying detection sensor 13, a second carrying detection sensor 14, a sheet carrying device 20, heating devices 15, stacking devices 22A, 22B, and 22C.

The sheet stacking tray 9 is a tray that stacks sheets of recording media (hereinafter, referred to simply as sheets) from which images are to be erased and feeds the sheets. The first sheet feeding roller 10 is a roller that successively takes in the sheets from the sheet stacking tray 9 by rotational driving.

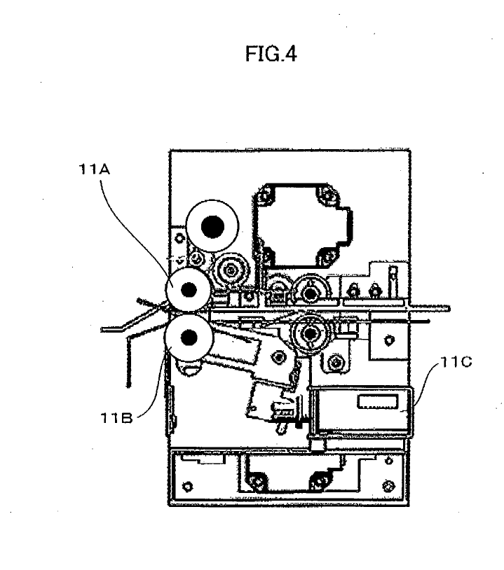

The separation rollers 11R and 11B are a pair of rollers that is provided downstream of the first sheet feeding roller 10 in a sheet carrying direction (the direction indicated by an arrow X) and separates the sheets by rotational driving. For example, if a bundle of unstapled sheets are taken in, the sheets can be separated using the related art to rotationally drive the separation roller 11A in the sheet carrying direction and the separation roller 11B in a direction opposite to the sheet carrying direction by a certain distance according to a control command from a control device described below. FIG. 4 is a cross section showing the structure of the separation rollers 11A and 11B of the image erasing apparatus 1 shown in FIG. 1.

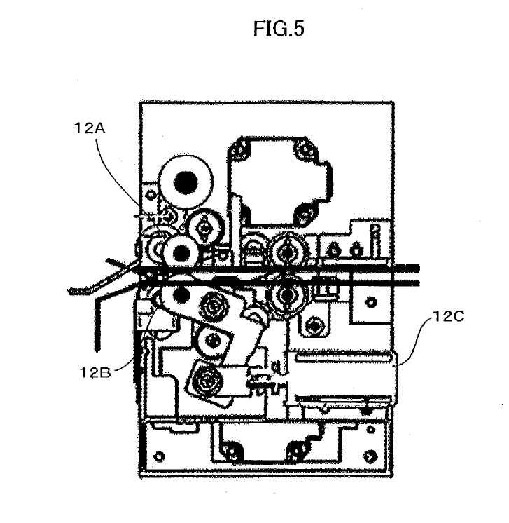

The second sheet feeding rollers 12A and 12B are a pair of rollers that is provided downstream of a pair of the separation rollers 11A and 11B in the sheet carrying direction and carries the sheets in the sheet carrying direction by rotational driving. FIG. 5 is a cross section showing the structure of the second sheet feeding rollers 12A and 12B of the image erasing apparatus 1 shown in FIG. 1.

The first carrying detection sensor 13 is a sensor that is provided in the vicinity of the second sheet feeding rollers 12A and 12B or downstream thereof in the sheet carrying direction and detects the sheets passing through a space between the separation rollers 11A and 118. A reflective or transmissive photo-sensor or a thickness detection sensor or a combination thereof can be used as the first carrying detection sensor 13.

The second carrying detection sensor 14 is a sensor that is provided downstream of the first carrying detection sensor 13 in the sheet carrying direction and detects not only passing of the sheets but also a completion of separation of the sheets in cooperation with the first carrying detection sensor 13. A sensor of the same type as the first carrying detection sensor 13 can be used as the second carrying detection sensor 14.

The heating device 15 is a device that is provided downstream of the second carrying detection sensor 14 and erases images formed on the sheets carried therein by heating the sheets to or above a color erasing temperature of a developer. The heating device 15 is provided on each side of the sheet carrying device 20 in a pair. The heating device 15 heats the sheets to a color erasing temperature at or above which the color of a developer on the sheets disappears. As the developer, a color-erasable ink, such as a leuco dye, is used and the color of the color-erasable ink is erased when it is heated to or above a certain temperature (for example, 80 to 100° C.)

Scanners 16A and 16B are devices that are provided downstream of the heating devices 15 in the sheet carrying direction and optically read images on the sheets. The scanners 16A and 16B are provided, respectively, on the both sides of the sheet carrying device 20 in a pair. The control device described below determines a success or a failure of the image erasing on the sheets on the basis of outputs of the scanners 16A and 16B.

The sheet carrying device 20 is formed of a plurality of pairs of carrying rollers 20A and 208 provided on sheet carrying paths connecting the sheet stacking tray 9 and the respective stacking devices 22A, 22B, and 22C and a switching device 21 that switches the carrying paths, and carries the sheets inside the image erasing apparatus 1.

The switching device 21 sorts unstapled sheets according to sheet sizes and stacks the sorted sheets in the stacking devices 22A or the stacking device 22B and stacks a bundle of stapled sheets in the stacking device 22C. Sheet storing destinations may be classified further according to a success or a failure of the image erasing.

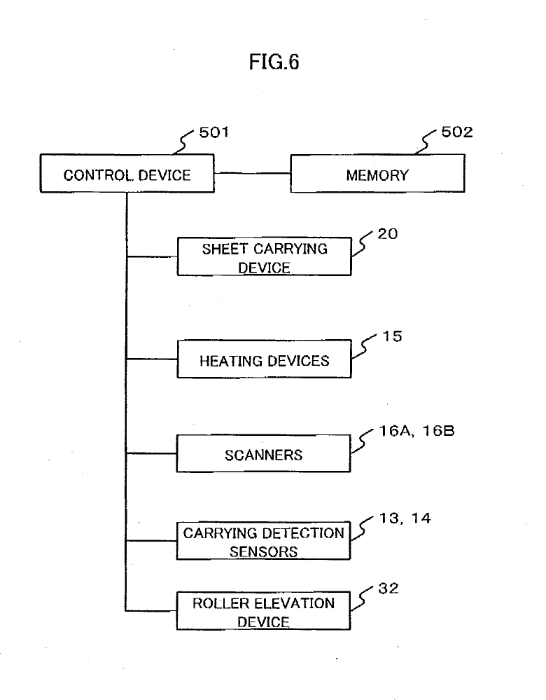

FIG. 6 is a block diagram showing the configuration of the image erasing apparatus 1 shown in FIG. 1. As is shown in FIG. 6, connected to a control device 501 of the image erasing apparatus 1 are a memory 502, the sheet carrying device 20, the heating devices 15, the scanners 16A and 16B, the carrying detection sensors 13 and 14, and a roller elevation device 32, and the control device 501 controls each of the connected devices and components. As the control device 501, a CPU (Central Processing Unit) and an MPU (Micro Processing Unit) capable of executing comparable arithmetic processing to that by the CPU are available.

Upon detection of carrying of sheets on the basis of an output of the first carrying detection sensor 13, the control device 501 controls one of a pair of the separation rollers 11A and 11B to be rotationally driven in the sheet carrying direction and the other in a direction opposite to the sheet carrying direction by a certain distance. A carrying distance can be changed as needed.

If a double feeding state in the first carrying detection sensor 13 is not cancelled even at an elapse of a predetermined time since the sheet separation by a pair of the separation rollers 11A and 11B started and the second carrying detection sensor 14 does not detect passing of the sheets, the control device 501 determines that a double-fed bundle of sheets are stapled. In this case, the control device 501 drives the separation rollers 11A and 11B and a pair of the second sheet feeding rollers 12A and 12B by means of the roller elevation device 32, so that the separation rollers 11A and 11B are spaced apart from the bundle of sheets, which is a carrying subject, while a pair of the second sheet feeding rollers 12A and 12B nips and carries the bundle of sheets.

Further, the control device 501 controls sheet carrying by the sheet carrying device 20 and ON and OFF switching and the heating temperature of the heating devices 15.

The memory 502 is a storage device that temporarily stores programs for the image erasing apparatus 1 to execute various processes and detection values of various sensors. The memory 502 can be formed, for example, of a RAM (Random Access Memory), a ROM (Read Only Memory), a DRAM (Dynamic Random Access Memory), an SRAM (Static Random Access Memory), a VRAM (Video RAM), and a flash memory.

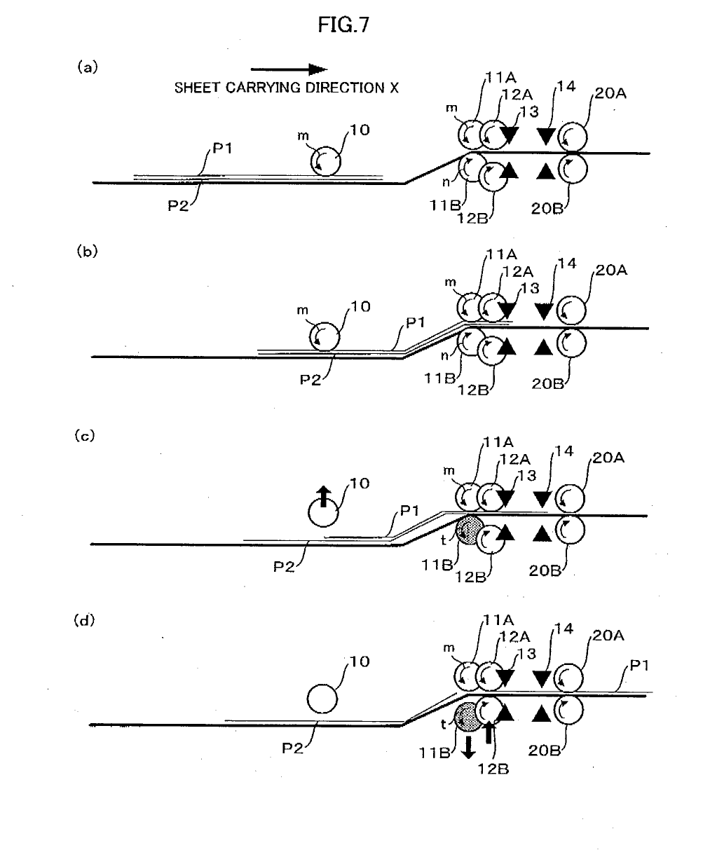

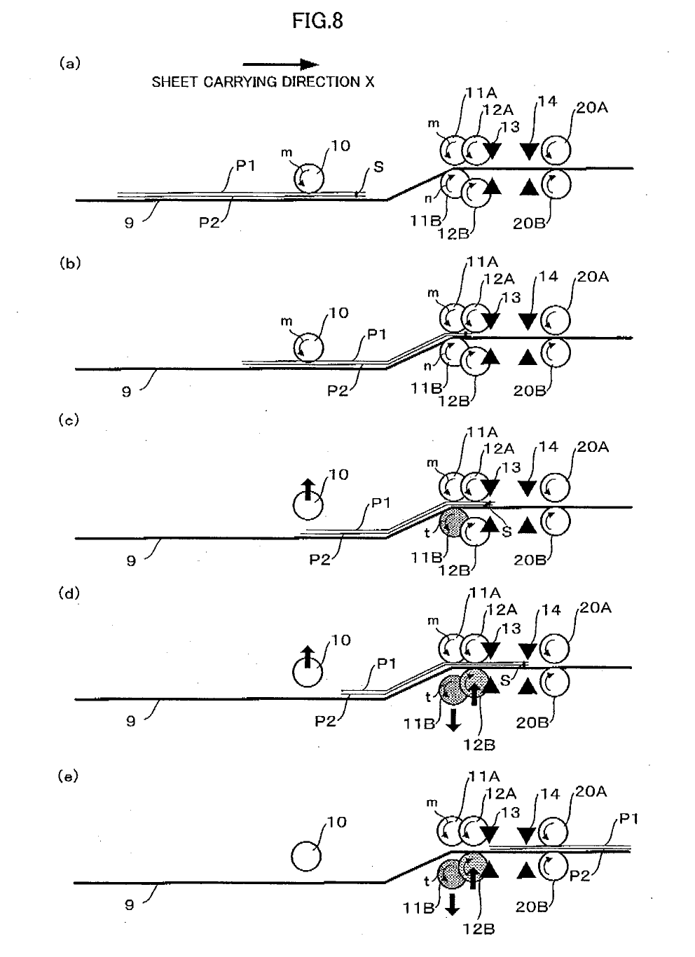

Hereinafter, a sheet carrying method of the image erasing apparatus 1 configured as above will be described on the basis of FIG. 7(a) through FIG. 7(d) and FIG. 8(a) through FIG. 8(e).

FIG. 7(a) through FIG. 7(d) are views used to describe a sheet carrying method for unstapled sheets. Herein, double feeding of a bundle of a sheet P1 and a sheet P2 will be described by way of example.

Initially, if the user makes an image erasing request using an operation button (not shown), the control device 501 rotationally drives the first sheet feeding roller 10 in the direction indicated by an arrow m and starts carrying of reuse sheets from the sheet stacking tray 9 (FIG. 7(a)).

Then, the tip end of the bundle of sheets passes through a space between a pair of the separation rollers 11A and 11B and reaches a space between a pair of the second sheet feeding rollers 12A and 12B (FIG. 7(b)). Because the first carrying detection sensor 13 is provided in the vicinity of the second sheet feeding rollers 12A and 12B, the first carrying detection sensor 13 is capable of detecting the tip end of the bundle of sheets passing through a space between the separation rollers 11A and 11B. In this instance, the first carrying detection sensor 13 outputs a sheet passing signal to the control device 501.

Subsequently, upon detection of the passing of the sheets on the basis of the output of the first carrying detection sensor 13, the control device 501 controls the separation roller 11A provided on the top surface side of the bundle of sheets to be rotationally driven in the sheet carrying direction (the direction indicated by an arrow m) and the separation roller 11B provided on the bottom surface side of the bundle of sheets in a direction opposite to the sheet carrying direction (the direction indicated by an arrow t) by a certain distance (FIG. 7(c)). The term, “a certain distance”, referred to herein means a distance long enough to separate double-fed sheets. For example, given that a distance between the nip position of a pair of the separation rollers 11A and 11B and the position of the second carrying detection sensor 14 is 10 mm, then the control device 501 carries the sheets in the opposite direction by about 15 mm, that is, a distance about 1.5 times longer. If the second carrying detection sensor 14 detects the arrival of the sheet P1 moved in the sheet carrying direction, the control device 501 moves the separation roller 11B downward to be spaced apart from the sheet P2.

The control device 501 then detects a sheet passing signal from the second carrying detection sensor 14 while continuing the carrying of the sheet P1 spaced apart from a pair of the separation rollers 11A and 11B by means of the second sheet feeding rollers 12A and 12B and the sheet carrying rollers 20A and 20B. Meanwhile, the sheet P2 moves in a direction to the sheet stacking tray 9 (FIG. 7(d)).

Owing to the drive control as above, even if a plurality of sheets are double-fed to the separation rollers 11A and 118, it becomes possible to separate the sheets one by one, which can in turn prevent the occurrence of a jamming.

FIG. 8(a) through FIG. 8(e) are views used to describe a sheet carrying method for stapled sheets. Herein, double feeding of a bundle of stapled sheet P1 and sheet P2 will be described by way of example. In the drawings, a capital S indicates the position of a staple.

Initially, if the user makes an image erasing request using the operation button (not shown), the control device 501 rotationally drives the first sheet feeding roller 10 in the direction indicated by an arrow m and starts carrying of reuse sheets from the sheet stacking tray 9 (FIG. 8(a)).

Then, the tip end of the bundle of sheets passes through a space between a pair of the separation rollers 11A and 11B and reaches a space between a pair of the second sheet feeding rollers 12A and 12B (FIG. 8(b)). Because the first carrying detection sensor 13 is provided in the vicinity of the second sheet feeding rollers 12A and 12B, the first carrying detection sensor 13 is capable of detecting the tip end of the bundle of sheets passing through a space between the separation rollers 11A and 11B. In this instance, the first carrying detection sensor 13 outputs a sheet passing signal to the control device 501.

Subsequently, upon detection of the passing of the sheets on the basis of the output of the first carrying detection sensor 13, the control device 501 controls the separation roller 11A provided on the top surface side of the bundle of sheets to be rotationally driven in the sheet carrying direction (the direction indicated by an arrow m) and the separation roller 11B provided on the bottom surface side of the bundle of sheets in a direction opposite to the sheet carrying direction (the direction indicated by an arrow t) by a certain distance. However, if the sheets are stapled, the bundle of sheets is pulled upstream and downstream in the sheet carrying direction. Hence, the sheets are not separated satisfactorily and the bundle of a plurality of sheets gets stuck in the vicinity of the first carrying detection sensor 13.

Because a double feeding state of the sheets in the first carrying detection sensor 13 is not cancelled even at an elapse of a predetermined time since sheet separation by a pair of the separation rollers 11A and 1113 started and the second carrying detection sensor 14 does not detect passing of the sheets, the control device 501 determines that a carrying subject is a bundle of stapled sheets (FIG. 8(c)). In this instance, the second carrying detection sensor 14 outputs a sheet double feeding detection signal and a staple detection signal to the control device 501.

Subsequently, upon detection of double feeding of the sheets and the presence of a staple on the basis of the outputs of the first carrying detection sensor 13 and the second carrying detection sensor 14, the control device 501 drives the separation roller 11B downward and the second sheet feeding roller 12B upward by means of the roller elevation device 32. Accordingly, a pair of the second sheet feeding rollers 12A and 12B nips and carries the bundle of sheets, which is the carrying subject. Eventually, the tip end of the bundle of sheets reaches the second carrying detection sensor 14 (FIG. 8(d)).

Then, the control device 501 detects a sheet passing signal from the second carrying detection sensor 14 while continuing the carrying of the bundle of sheets by means of the sheet feeding rollers 12A and 12B and the sheet carrying rollers 20A and 20B (FIG. 8(e)).

Owing to the drive control as above, even if a bundle of stapled sheets is carried in, it becomes possible to prevent a sheet carrying failure by controlling the rotation directions and the elevation driving of the separation rollers 11A and 11B and the second sheet feeding rollers 12A and 12B. In addition, the heating devices 15 become capable of erasing images on sheets bundle by bundle.

### Second Embodiment

A second embodiment of the invention will now be described. In this embodiment, an ultrasonic sensor is used as the first carrying detection sensor 13 to determine not only passing of sheets but also double feeding of sheets simultaneously.

Hereinafter, a difference from the first embodiment above will be described with reference to FIG. 8(a) through FIG. 8(e). FIG. 8(a) through FIG. 8(e) are views used to describe the sheet carrying method for stapled sheets. Herein, double feeding of a bundle of stapled sheet P1 and sheet P2 will be described by way of example. In the drawings, a capital S denotes the position of a staple.

Initially, if the user makes an image erasing request using the operation button (not shown), the control device 501 rotationally drives the first sheet feeding roller 10 in the direction indicated by an arrow m and starts carrying of reuse sheets from the sheet stacking tray 9 (FIG. 8(a)).

Then, the tip end of the bundle of sheets passes through a space between a pair of the separation rollers 11A and 11B and reaches a space between a pair of the second sheet feeding rollers 12A and 12B (FIG. 8(b)). Because the first carrying detection sensor 13 is provided in the vicinity of the second sheet feeding rollers 12A and 12B, the first carrying detection sensor 13 is capable of detecting the tip end of the bundle of sheets passing through a space between the separation rollers 11A and 11B. Also, the first carrying detection sensor 13, which is an ultrasonic sensor, detects that carried sheets are a bundle of a plurality of sheets and outputs a detection signal of the bundle of sheets (double feeding signal) together with a sheet passing signal to the control device 501.

Subsequently, upon detection of the passing and the double feeding of the bundle of sheets on the basis of the outputs of the first carrying detection sensor 13, the control device 501 controls the separation roller 11A provided on the top surface side of the bundle of sheets to be rotationally driven in the sheet carrying direction (the direction indicated by an arrow m) and the separation roller 118 provided on the bottom surface side of the bundle of sheets in a direction opposite to the sheet carrying direction (the direction indicated by an arrow t) by a certain distance. However, if the sheets are stapled, the bundle of sheets is pulled upstream and downstream in the sheet carrying direction. Hence, the sheets are not separated satisfactory and the bundle of a plurality of sheets gets stuck in the vicinity of the first carrying detection sensor 13.

Because a double feeding state of the sheets in the first carrying detection sensor 13 is not cancelled even at an elapse of a predetermined time since sheet separation by a pair of the separation rollers 11A and 11B started, the control device 501 determines that a carrying subject is a bundle of stapled sheets (FIG. 8(c)). In this instance, the second carrying detection sensor 14 outputs a sheet double feeding detection signal and a staple detection signal to the control device 501. Subsequently, upon detection of double feeding of the sheets and the presence of a staple on the basis of the outputs of the first carrying detection sensor 13 and the second carrying detection sensor 14, the control device 501 drives the separation roller 11B downward and the second sheet feeding roller 12B upward by means of the roller elevation device 32. Accordingly, a pair of the second sheet feeding rollers 12A and 12B nips and carries the bundle of sheets, which is the carrying subject. Eventually, the tip end of the bundle of sheets reaches the second carrying detection sensor 14 (FIG. 8(d)).

Then, the control device 501 detects a sheet passing signal from the second carrying detection sensor 14 while continuing the carrying of the bundle of sheets by means of the sheet feeding rollers 12A and 12B and the sheet carrying rollers 20A and 20B (FIG. 8(e)).

In this manner, by using an ultrasonic sensor as the first carrying detection sensor 13, it becomes possible in this embodiment to determine double feeding of sheets physically when the sheets passes by the first carrying detection sensor 13. Hence, there is an advantage that double feeding of sheets can be detected quickly.

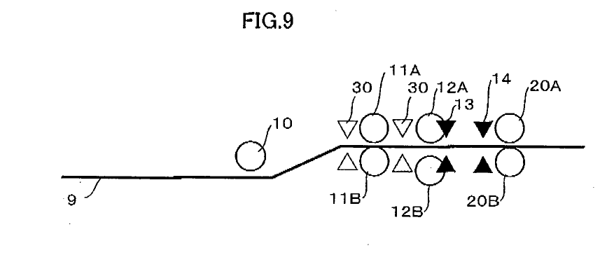

FIG. 9 is a view schematically showing the configuration of a major portion in an application example of the image erasing apparatus of the invention. This image erasing apparatus includes deflection detection sensors 30 provided between the first sheet feeding roller 10 and the separation rollers 11A and 11B and between the separation rollers 11A and 11B and the second sheet feeding rollers 12A and 12B to detect a force applied on the sheets. If the deflection detection sensors 30 detect a pressure as high as or higher than a predetermined threshold value, the control device 501 moves a pair of the separation rollers 11A and 11B to be spaced apart quickly from the sheets.

By providing the deflection detection sensors 30 in this manner, it becomes possible to physically determine whether the sheets are double-fed and the sheets are stapled. In this case, there is an advantage of allowing separation to be stopped without giving too much damage to the sheets.

While certain embodiments have been described these embodiments have been presented by way of example only, and are not intended to limit the scope of the inventions. Indeed, the novel apparatus and methods described herein may be embodied in a variety of other forms: furthermore various omissions, substitutions and changes in the form of the apparatus and methods described herein may be made without departing from the spirit of the inventions. The accompanying claims and there equivalents are intended to cover such forms of modifications as would fall within the scope and spirit of the invention.

What is claimed is:

1. An image erasing apparatus comprising:
a sheet stacking tray that feeds sheets from which images are to be erased;
a first sheet feeding roller that takes in the sheets from the sheet stacking tray;
a pair of separation rollers that is provided downstream of the first sheet feeding roller in a sheet carrying direction and separates the sheets;
a pair of second sheet feeding rollers that is provided downstream of the pair of separation rollers in the sheet carrying direction and carries the sheets in the sheet carrying direction;
a carrying detection sensor that is provided in a vicinity of the pair of second sheet carrying rollers and detects passing of the sheets;
a sheet carrying device that carries the sheets;
a heating device that is provided downstream of the carrying detection sensor in the sheet carrying direction and erases images formed on the sheets by heating the sheets to or above a color erasing temperature of a developer;
a stacking device that stacks the sheets from which the images are erased; and
a control device that rotationally drives, upon detection of double feeding of the sheets on the basis of an output of the carrying detection sensor, one of the pair of separation rollers in the sheet carrying direction and the other in a direction opposite to the sheet carrying direction by a certain distance.

2. The apparatus according to claim 1, wherein the carrying detection sensor includes:
a first carrying detection sensor that is provided to one of positions in a vicinity of the pair of second sheet feeding rollers and downstream thereof in the sheet carrying direction and detects the sheets passing through a space between the second sheet feeding rollers; and
a second carrying detection sensor that is provided downstream of the first carrying detection sensor in the sheet carrying direction and detects passing of the sheets and a completion of separation of the sheets.

3. The apparatus according to claim 2, wherein:
the control device determines whether sheets as a carrying subject are a bundle of stapled sheets on the basis of a time lag between outputs of the first carrying detection sensor and the second carrying detection sensor.

4. The apparatus according to claim 3 further comprising:
a roller elevation device that moves up and down the pair of second sheet feeding rollers,
wherein if the control device determines that the sheets as the carrying subject are a bundle of stapled sheets, the roller elevation device moves the pair of second sheet feeding rollers being rotationally driven in the sheet carrying direction to nip the bundle of sheets.

5. The apparatus according to claim 4, wherein:
the first carrying detection sensor is an ultrasonic sensor that detects the sheets passing through the space between the second sheet feeding rollers and double feeding of the sheets.

6. The apparatus according to claim 4 further comprising:
a deflection detection sensor that is provided between the first sheet feeding roller and the pair of separation rollers and detects a force applied on the sheets from the separation rollers,
wherein the roller elevation device moves, if the deflection detection sensor detects a force as large as or larger than a predetermined threshold value, the pair of separation rollers to be spaced apart from the sheets.

7. The apparatus according to claim 4 further comprising:
a switching device that is provided downstream of the heating device in the sheet carrying direction and switches carrying paths according to one of a size of the sheets as the carrying subject, a success or a failure of image erasing, and the number of the sheets.

8. The apparatus according to claim 7, wherein:
if the control device determines that the carrying subject is a bundle of stapled sheets, the switching device makes a switching to a carrying path for a bundle of sheets.

9. The apparatus according to claim 2, wherein:
upon detection of the double feeding of the sheets on the basis of outputs of the first carrying detection sensor and the second carrying detection sensor, the control device rotationally drives one of the pair of separation rollers in the sheet carrying direction and the other in a direction opposite to the sheet carrying direction by the certain distance, the certain distance being about 1.5 times longer than a distance between a nip position of the pair of separation rollers and the second carrying detection sensor.

10. The apparatus according to claim 4 further comprising:
a scanner that is provided downstream of the heating device in the sheet carrying direction and optically reads the images on the sheets heated by the heating device,
wherein the control device determines a success or a failure of image erasing on the basis of an output of the scanner.

11. A sheet carrying method of an image erasing apparatus comprising:
taking in sheets by a first sheet feeding roller from a sheet stacking tray that stacks sheets from which images are to be erased;
separating the taken sheets by a pair of separation rollers provided downstream of the first sheet feeding roller in a sheet carrying direction;
carrying the separated sheets in the sheet carrying direction by a pair of second sheet feeding rollers provided downstream of the pair of separation rollers in the sheet carrying direction;
detecting passing of the sheets and double feeding of the sheets carried from the pair of second sheet feeding rollers by a carrying detection sensor provided in a vicinity of the pair of second sheet feeding rollers;
rotationally driving, upon detection of the double feeding of the sheets on the basis of an output of the carrying detection sensor, one of the pair of separation rollers in the sheet carrying direction and the other in a direction opposite to the sheet carrying direction by a certain distance to separate the sheets by a control device that controls the pair of separation roller; and
erasing images formed on the sheets by heating the sheets to or above a color erasing temperature of a developer by a heating device provided downstream of the carrying detection sensor in the sheet carrying direction if the control device detects a completion of separation of the sheets on the basis of an output of the carrying detection sensor.

12. The method according to claim 11, wherein:
the sheets passing through a space between the pair of second sheet feeding rollers is detected by a first carrying detection sensor provided to one of positions in a vicinity of the pair of second sheet feeding rollers and downstream thereof in the sheet carrying direction;
the passing of the sheets and the completion of separation of the sheets are detected by a second carrying detection sensor provided downstream of the first carrying detection sensor in the sheet carrying direction; and
the control device determines an occurrence and a non-occurrence of the double feeding of the sheets on a basis of a time lag between outputs of the first carrying detection sensor and the second carrying detection sensor.

13. The method according to claim 12, wherein:
the control device determines whether sheets as a carrying subject are a bundle of stapled sheets on the basis of the time lag between the outputs of the first carrying detection sensor and the second carrying detection sensor.

14. The method according to claim 13, wherein:
if the control device determines that sheets as the carrying subject are a bundle of stapled sheets, a roller elevation device that moves up and down the pair of second sheet feeding rollers moves the pair of second sheet feeding rollers so that the pair of second sheet feeding rollers being rotationally driven in the sheet carrying direction nips the bundle of sheets.

15. The method according to claim 14, wherein:
the first carrying detection sensor detects the sheets passing through the space between the second sheet feeding rollers and double feeding of the sheets.

16. The method according to claim 14, wherein:
if a force as large as or larger than a predetermined threshold value is detected by a deflection detection sensor provided between the first sheet feeding roller and the pair of separation rollers and detecting a force applied on the sheets from the separation rollers, the roller elevation device moves the pair of separation rollers to be spaced apart from the sheets.

17. The method according to claim 14, wherein:
carrying paths are switched according to one of a size of the sheets as the carrying subject, a success or a failure of image erasing, and the number of the sheets by a switching device provided downstream of the heating device in the sheet carrying direction.

18. The method according to claim 17, wherein:
the switching device makes a switching to a sheet carrying path for a bundle of sheets if the control device determines that the carrying subject is a bundle of stapled sheets,

19. The method according to claim 12, wherein:
when the control device rotationally drives one of the pair of separation rollers in the sheet carrying direction and the other in a direction opposite to the sheet carrying direction by the certain distance upon detection of the double feeding of the sheets on the basis of outputs of the first carrying detection sensor and the second carrying detection sensor, the certain distance is set to be about 1.5 times longer than a distance between a nip position of the pair of separation rollers and the second carrying detection sensor.

20. The method according to claim 14, wherein:
the images on the sheets heated by the heating device are optically read by a scanner provided downstream of the heating device in the sheet carrying direction; and
the control device determines a success or a failure of image erasing on the basis of an output of the scanner.
